(19) United States
(12) Patent Application Publication
(10) Pub. No.: US 2002/0043170 A1
(43) Pub. Date: Apr. 18, 2002

(54) System and method for preparing and utilizing a printing member having magnetic particles therein

(76) Inventors: Rafael Bronstein, Kfar Saba (IL); Murray Figov, Ra'anana (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/888,603

(22) Filed: Jun. 26, 2001

Related U.S. Application Data
(63) Continuation-in-part of application No. 09/480,447, filed on Jan. 10, 2000, now Pat. No. 6,308,628.

(51) Int. Cl. B41F 1/00; B41N 3/00

(52) U.S. Cl. 101/453

(57) ABSTRACT

An ablatable printing member comprising a base material and a coating is provided. The coating may comprise at least one polymeric layer containing magnetic particles embedded therein. In another application, an erasable printing member comprising a base material and an emulsion coating is provided. The emulsion coating may comprise a polymer dispersed with magnetic particles and may have a relatively low glass transition temperature.

### CROSS-REFERENCE TO RELATED APPLICATIONS

The present application is a Continuation-in Part Patent Application of U.S. Patent Application Ser. No. 09/480,447, filed Jan. 10, 2000, which is incorporated herein by reference in its entirety.

### BACKGROUND OF THE INVENTION

Lithography or offset printing is currently the dominant printing technology. The printing is typically performed by an ablatable printing plate. The ablation process is accompanied by the generation of a large amount of imaging debris and it is necessary to clean the plate and remove this debris before the printing process is commenced. The debris also interferes with the laser radiation by depositing on the focusing lens as an aerosol or mist of fine particles that block the laser radiation transmission. This creates a need for a frequent cleaning of the optics and the exposure compartment.

Different means have been tried to protect the exposure optics and plate surface from ablation debris. Typically, these are mechanical shutters and baffles that absorb part of the flying debris. Vacuum or a directed airflow through the gap between the exposure head and the plate may also assist in the debris evacuation procedure. However, it may be effective only in cases where all the protective or oleophobic silicone layer particles are pulled off the plate and are airborne. Should some particles remain attached to the substrate, the vacuum assistance is of no use. Further, both the airflow and the vacuum create vortices that cause debris deposition on other parts of the system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanying drawings in which:

FIG. 1A is a simplified illustration of a prior art ablatable film;

FIG. 1B is a simplified illustration of a prior art polyester plate;

FIG. 2 is a simplified illustration of a prior art imaging method of ablatable film and plate;

FIG. 3 is a schematic illustration of a basic structure of a processless/self-cleaning ablation film or plate, constructed in accordance with some embodiments of the present invention;

FIG. 4 is a schematic illustration of the ablation apparatus and an ablation method, with automatic debris collection of the processless/self cleaning ablation film or plate of FIG. 3, constructed in accordance with some embodiments of the present invention;

FIG. 5 is a schematic illustration of an ablation apparatus and an ablation method, with automatic debris collection, of the processless/self cleaning ablation plate constructed in accordance with some embodiments of the present invention;

FIGS. 6A, 6B, 6C and 6D are additional schematic illustrations of ablation apparatuses and methods, with automatic debris collection of the processless/self cleaning ablation plate constructed in accordance with some embodiments of the present invention;

FIG. 7 is a schematic illustration of a basic structure of a direct imaging flexographic plate with a self-cleaning ablation coating, constructed in accordance with some embodiments of the present invention;

FIG. 8 is a schematic illustration of the ablation process with automatic debris collection, of the direct imaging flexographic plate with the self cleaning ablation coating of FIG. 7;

FIG. 9, is a schematic illustration of a basic structure of an erasable offset printing plate, according to some embodiments of the present invention;

FIG. 10 is a schematic illustration of the exposure process of the erasable offset printing plate of FIG. 9;

FIG. 11 is a schematic illustration of the process of erasure of the information from the erasable offset printing plate of FIG. 9;

FIG. 12 shows a basic structure of an erasable relief printing plate and principles of am exposure apparatus adapted for his purpose, according to some embodiments of the present invention; and

FIG. 13 schematically illustrates a press with printing cylinders coated with the erasable offset printing plate emulsion or with the erasable relief printing plate material according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

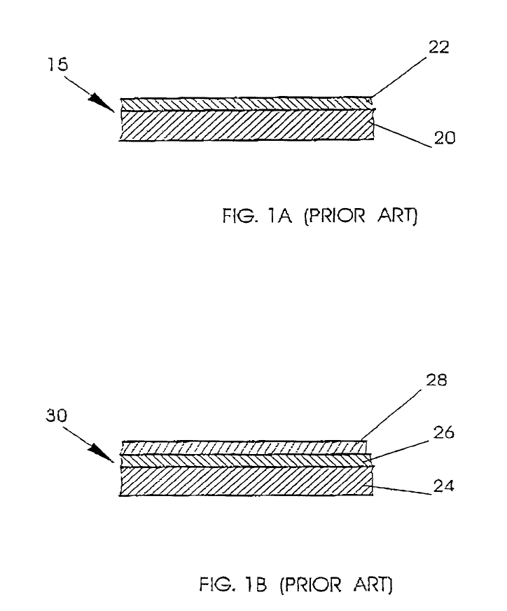

FIG. 1A is a schematic illustration of a prior art ablatable film, generally denoted by numeral 15, consisting, for the simplicity of explanation, of a film base 20, typically polyester and an ablatable layer 22. The ablatable layer 22 should be dark enough to provide the desired optical density and may include some dyes or pigments that enhance the heat or infrared radiation absorption process and stimulate the ablation processing.

FIG. 1B is a simplified illustration of prior art ablatable plate, generally denoted by numeral 30, consisting, for the simplicity of explanation, of a metal base 24, typically aluminum, a layer 26 capable of absorbing infrared radiation and a surface coating layer 28. The surface coating layer 28 may be oleophobic for waterless printing plates or either hydrophobic or hydrophilic for wet printing plates.

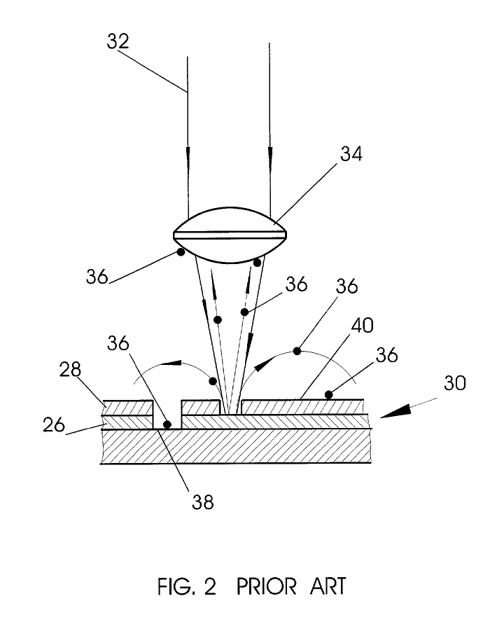

FIG. 2 is a simplified illustration of a prior art imaging method of ablatable film or plate. The ablatable plate, generally denoted by numeral 30, is ablated/exposed by a laser beam 32 focused on the plate surface by a lens 34. Numerals 36 indicate the ablation debris, resulting from the ablation of layers 26 and 28. The debris 36, pushed by the micro explosion forces of the ablation process, is deposited on the already ablated areas 38 of the plate, on the not yet ablated areas 40 of the coating 28 and on the lens 34.

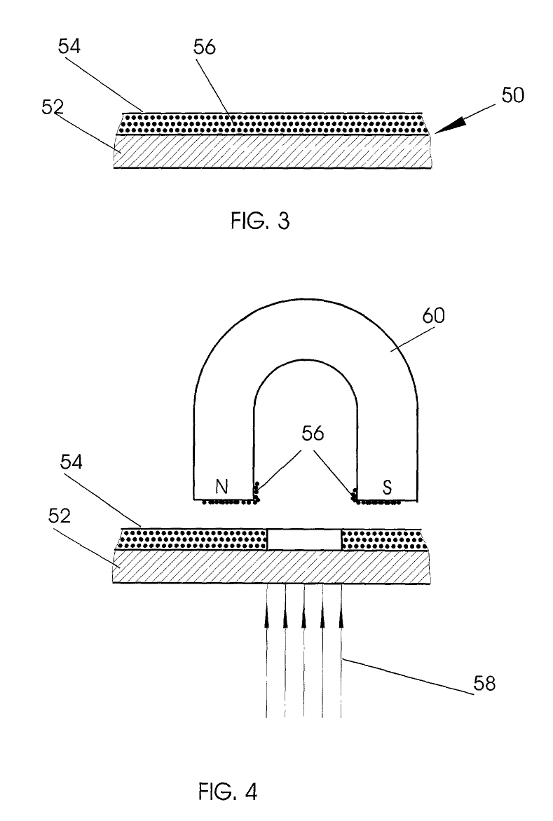

FIG. 3 is a schematic illustration of the basic structure of a processless/self-cleaning ablation film or plate, generally denoted by numeral 50, constructed in accordance with some embodiments of the present invention. The ablation film or plate may comprise a base material 52 and a coating 54. The base material 52 may be transparent or opaque. Transparent polyester film for example, may be used as base material 52 and is readily available from a number of suppliers. One such film is MYLAR film sold by E. I. dupont de Nemours Co., Wilmington, Del., U.S.A. Another is the NELINEX film sold by ICI Films, Wilmington, Del., U.S.A. The thickness of polyester-film for plates may be approximately 0.007 inch, but thinner or thicker versions may be used as well. The thickness of polyester-film for films may be 0.004 inch, but different thickness may also be used. The coating layer 54 may be a polymer, dispersed with magnetic particles, for instance magnetite particles 56. The magnetite particles 56 may be such as MO 8029 or MO 4431, commercially available from ISK Magnetics, Inc., Valparaiso, Ind., U.S.A. The magnetic particles 56 may typically have sizes of approximately 0.8 to 1.0 micron and are well compatible with the thickness of the coating layer 54. There is no need to place the magnetite particles 56 in an orderly manner within the coating layer 54. The magnetite particles 56 are most advantageously dispersed in silicone and cellulose, of the type described in connection with coating layer 54 and given in the examples below.

### Example 1

### Ablatable Plate—First Coat of a Waterless Plate

The following coating formulation was prepared as a mixture (all numbers designating parts in formulations are given in units indicating their relative part of the overall weight of the formulation).

| | |
|---|---|
| Cellulose Nitrate | 20 parts |
| Methyl Ethyl Ketone | 120 parts |
| Z Mag 1101 (magnetic iron oxide) | 35 parts |

The mixture was milled for 12 hours, to ensure a fine dispersion of the iron oxide pigment and then the following ingredients were stirred in:

| | |
|---|---|
| Cymel 1170 | 7 parts |
| Cycat 4040 | 0.7 parts |

Both materials are commercially available from Dyno-Cytec K.S., Litlestrom, Norway.

The mixture was then bar-coated onto 175 micron thick MELINEX 339 base polyester sheet and dried for 3 minutes at 140° C. to a dry coating weight of 4 grams per square meter.

Next the following mixture was prepared:

Ablatable Plate-Second Coat of a Waterless Plate

| | |
|---|---|
| Alcosil #2 Catalyst A | 50 parts |
| Alcosil #2 Catalyst B | 25 parts |
| Alcosil #2 Silicone Gum | 25 parts |

All of the above materials are commercially available from J. Alcock and Sons Ltd. Manchester, England.

The mixture was then bar-coated onto the previous layer and dried for 3 minutes at 140° C. to a dry coating weight of 2 grams per square meter.

### Example 2

### Ablatable Film

The formulation used for the first coat of Example 1 was coated onto 100-micron polyester base and dried for 4 minutes at 140° C. to a dry thickness of 6 microns.

FIG. 4 is a simplified illustration of the ablation apparatus method, with automatic debris collection of the self-cleaning ablation film of FIG. 3 in accordance with some embodiments of the present invention. The exposure/ablation of the film in the case of a transparent substrate may be performed by a laser 58, which in particular case exposes through the transparent base layer 52. The removal of material from the coating layer 54 and the capture of magnetic particles 56 is aided by an electro-magnet or a permanent magnet 60, that attracts the magnetic particles 56 together with the coating material of the film base 52 that surrounds them. The gap between the coating layer 54 and the permanent magnet (or an electromagnet) 60, may be selected to create the pulling forces required to attract the debris to the magnet. Such selection is well within the scope of the skilled person, and is therefore not discussed herein in details, for the sake of brevity. Cleaning the permanent magnet 60 from the attracted magnetic particles 56 and debris may be performed at a later stage, by any known cleaning method.

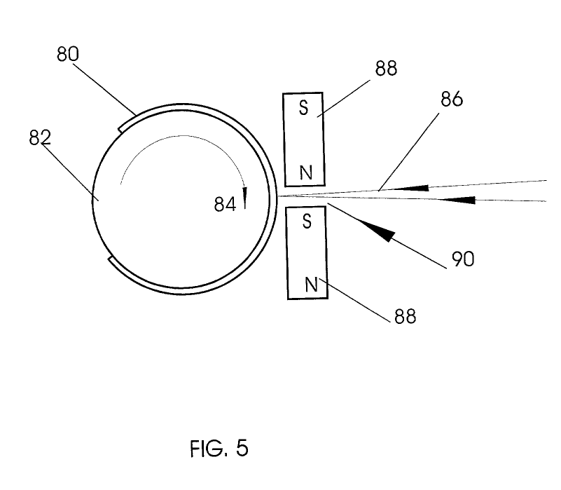

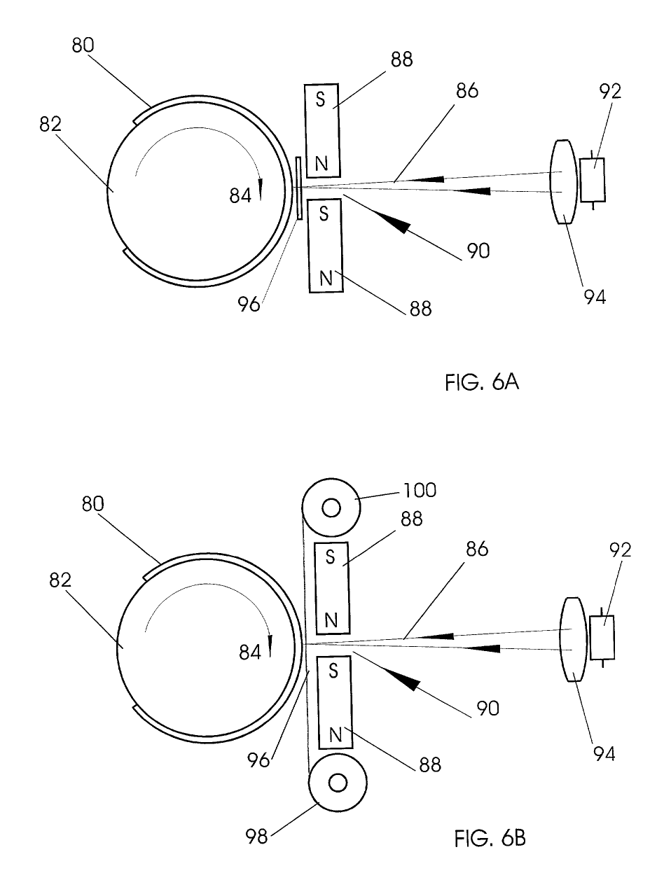

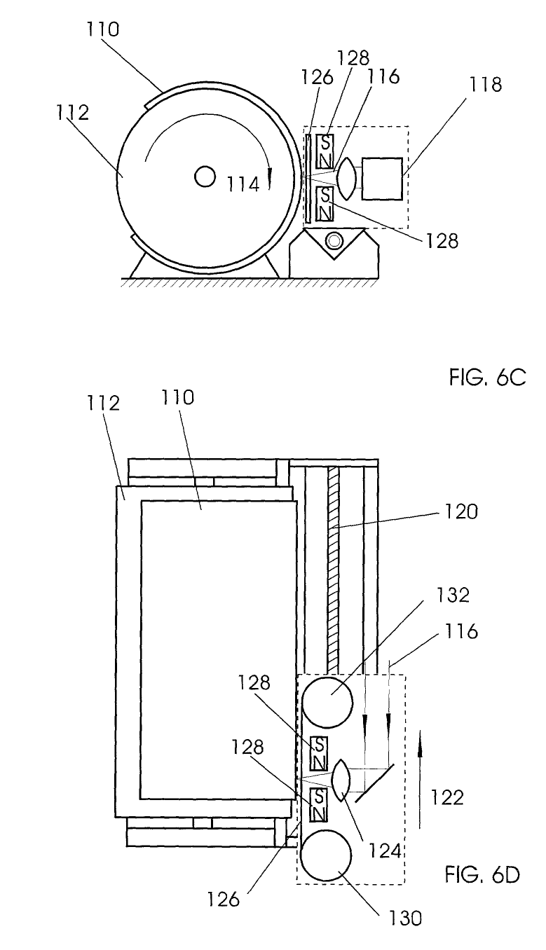

FIG. 5 is a schematic illustration of an ablation apparatus operating according to some embodiments of the invention, using the processless/self-cleaning ablation plate of Fig. 3. A plate 80, in this case, is opaque and is typically a metal substrate such as an aluminum plate used in offset printing. The plate 80 may be mounted on a rotating drum 82 that rotates in the direction indicated by arrow 84. The coating on the plate may be ablated by a scanning laser beam 86. A pair of permanent magnets 88 may be placed in front of the ablatable surface of plate 80. Non-limiting example of such a magnet may be a pair of permanent rectangular block sintered ferrite magnets of Feroba type, commercially available from Eclipse Magnetics Ltd., Sheffield S9 lEW, England. The magnets 88 may be arranged so that the gap 90 between them is approximately between 2 mm to 3 mm wide and their distance from the drum is between 1 mm to 2 mm. The pair of magnets 88 may capture the ablation debris. This arrangement may protect the optics from becoming dirty. There is also no debris left on the plate surface. Cleaning of the permanent magnets 88 from the attracted magnetic particles my be performed later, by any known cleaning method. The need for this cleaning of the permanent magnets 88, after the plate ablation has been completed, may be eliminated by employing the embodiments shown on FIGS. 6A through 6D and explained hereinbelow.

FIGS. 6A and 6B are schematic illustrations of the ablation apparatus and an ablation method with automatic debris collection of the processless/self cleaning ablation plate, constructed in accordance with some embodiments of the present invention.

FIG. 6A is a side view of a flat field type apparatus for ablation of the processless/self-cleaning printing member. The printing member/plate 80 may be mounted on a rotating drum 82 that rotates in the direction indicated by arrow 84. The coating on the plate may be ablated by a scanning laser beam 86. An oscillating mirror 92, or a rotating polygon, may provide the laser beam scanning action. The scanning beam may be focused by a flat field lens 94. A thin transparent MYLAR film 96, with thickness of approximately 25 to 50 microns, is placed between the plate and the pair of permanent rectangular block sintered ferrite magnets 88. The ablation debris attracted by the magnetic field forces precipitates on the MYLAR film 96. This arrangement may protect the optics from becoming dirty. The MYLAR film 96 may be easily removed and replaced when it becomes soiled/dirty.

FIG. 6B is a side view of an apparatus for ablation of the processless/self-cleaning printing member. It shows another arrangement of the apparatus of FIG. 6A, where the MYLAR film is continuously scrolled, from a supply cassette 98 to a receiving cassette 100. This arrangement may provide a continuously clean protective film that does not obstruct the ablating beam 86. The film 96 may be replaced after a number of plate exposures, by replacing the film cartridge, including both cassettes 98 and 100 and the film.

FIGS. 6C and 6D are, respectively, schematic illustrations of the side and top views of the ablation apparatus with automatic debris collection of the processless/self cleaning ablation plate, constructed in accordance with some embodiments of the present invention.

FIG. 6C is a side view of an external drum, single beam or multibeam type apparatus, for ablation of the processless/self-cleaning printing member. The printing member/plate 110 may be mounted on a rotating drum 112 that rotates in the direction indicated by arrow 114. A scanning laser beam 116 may ablate the coating on the plate. The beam may be provided by a laser (not shown) or a laser diode (not shown) external to the exposure head 118 and mounted on the head.

FIG. 6D is a top view of the apparatus for ablation of the processless/self-cleaning printing member. It shows an arrangement of the apparatus of FIG. 6C, where the MYLAR film is continuously scrolled from a supply cassette 130 to a receiving cassette 132. This arrangement may provide a continuously clean protective film that does not obstruct the ablating laser beam 116. The film 126 may be replaced after a number of plate exposures.

Lead screws 120 with a motor (not shown) may provide the laser beam scanning action in the slow scanning direction indicated by arrow 122. A lens 124 may focus the scanning beam. A thin transparent MYLAR film 126, with thickness of approximately 25 to 50 microns, may be placed between tie plate and the pair of permanent rectangular block sintered ferrite magnets 128. The ablation debris attracted by the magnetic field forces precipitate on the MYLAR film 126. This arrangement protects the optics from becoming dirty. The MYLAR film 126 may be removed and replaced when it becomes soiled/dirty.

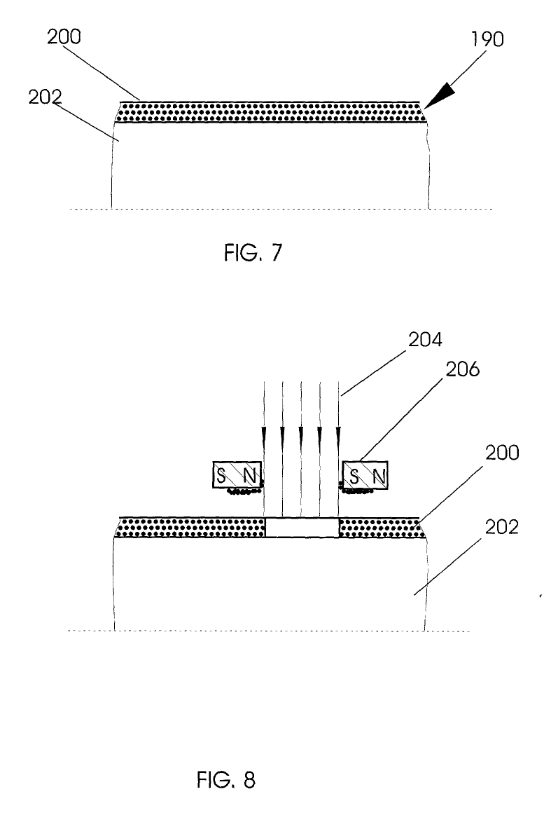

Reference is now made to FIG. 7, which is a schematic illustration of a basic structure of a direct imaging flexographic plate, generally denoted by numeral 190, with a self-cleaning ablation coating, constructed in accordance with some embodiments of the present invention. Here, the coating 200 is deposited over a flexographic plate 202. Current direct exposure flexographic plates may have a very thin ablatable coating of about 1-3 micron. The coating has to be easily ablated and dark enough to avoid UV penetration, used at the next exposure step, into the protected material. These two contradictory requirements are difficult to meet by regular ablatable coatings. The coating of the invention, dispersed with magnetic particles, produces a thick enough layer (depending on the load of particles) to avoid UV penetration and is easily ablatable.

Since the ablatable coating is washed off after UV curing, simple wax coating dispersed with magnetic particles may be used in this case.

FIG. 8 is a schematic illustration of the ablation process with automatic debris collection of the direct imaging flexographic plate 190 with the self cleaning ablation coating, of FIG. 7. The ablation may be performed by a laser beam 204, which may expose through an arrangement of a set of permanent magnets 206, similar to the one described earlier. As in the previous case, both the removal of coating material and the protection of the optics may be aided by the permanent magnets 206, that attract the magnetic particles of the coating 200 together with some coating material of the flexographic plate base 202. Electromagnetic elements may be used instead of the permanent magnets.

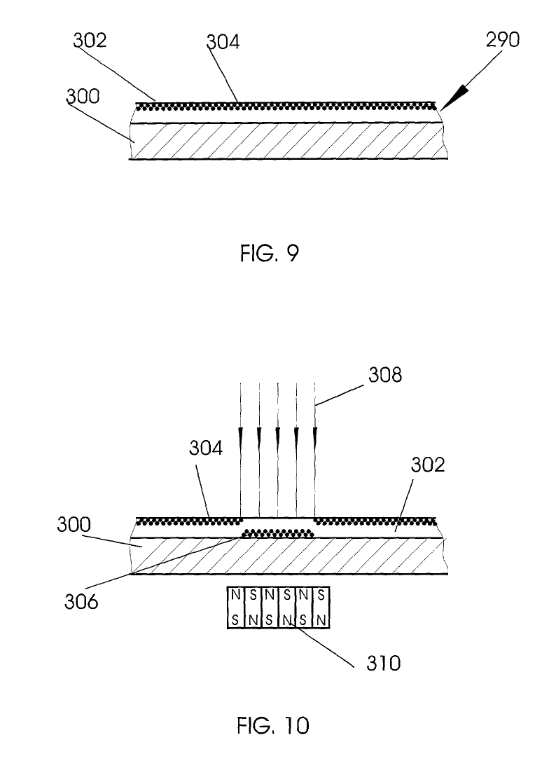

Reference is now made to FIG. 9, which is a schematic illustration of a basic structure of an erasable offset printing plate, generally denoted by numeral 290, comprising a base material 300 and a coating 302 according to some embodiments of the present invention. The emulsion coating may be a polymer, dispersed with magnetic particles 304. The coating 302 may have a relatively low Glass Transition Temperature (Tg) (and may be, e.g., polystyrene). During the coating process, the magnetic particles 304 dispersed in the coating material are arranged to occupy a permanent and organized position at the top or bottom of the coating layer. This may be achieved by applying a permanent magnetic field when the coating is applied. The coating may be applied as a solution.

The organized layer of magnetite particles should be very close to the surface of the coating 302, and even slightly protrude through it. Magnetite is typically hydrophilic and in such orientation will create a hydrophilic surface. The coating 302 should be hydrophobic/oleophilic.

FIG. 10 is simplified illustration of the exposure/imaging unit suitable for imaging the erasable offset printing plate 290 of FIG. 9. A laser beam may perform the exposure. The beam 308 may locally heat up the coating layer 302 to above its glass transition temperature, where the coating layer 302 becomes soft or even fluid. A multiple pole electro-magnet or a plurality of permanent magnets 310 that create a uniform magnetic field are placed beneath or above the plate base 300. This uniform magnetic field may attract and/or may move the magnetic particles 304 to a new position 306, on the bottom or top of he coating layer 302, depending on the location of the magnets relative to the plate. The exposed area now contains only the coating 302, which is oleophilic/hydrophobic.

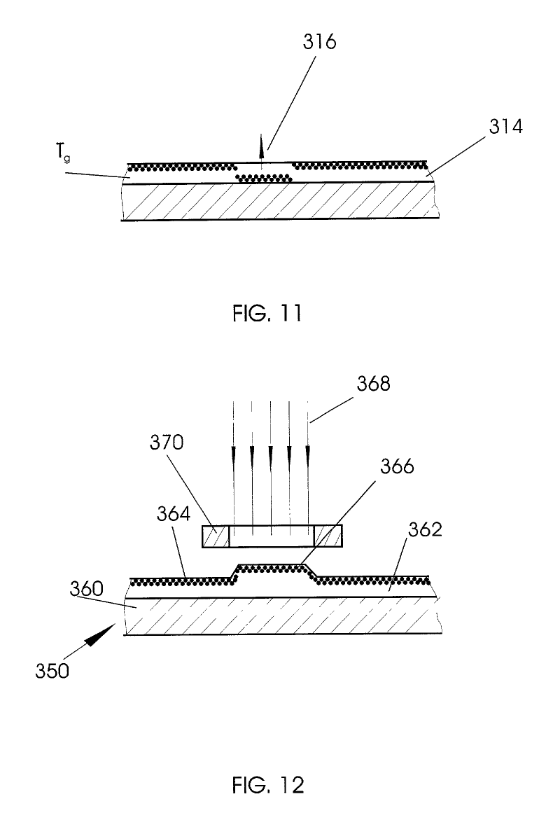

Upon completion of the printing process, the plate is erased, as shown in FIG. 11. Here the entire plate/coating layer 314 is heated to the glass transition temperature Tg and placed under or over a uniform/even magnetic field. This magnetic field may cause the magnetite particles to move to their initial or extreme position, as indicated by arrow 316.

Reference is now made to FIG. 12, which shows the basic structure of an erasable relief printing plate and schematically illustrates the principles of an exposure apparatus adapted for this purpose in accordance with some embodiments of the present invention. The erasable relief printing plate, generally denoted by numeral 350, may comprise a base material 360 and an emulsion coating 362. The emulsion coating may be a regular polymer dispersed with magnetic particles 364. The magnetic particles 364 may, but do not have to, be placed in an orderly position. The emulsion 362 may have a relatively low Glass Transition Temperature Tg (e.g., that of polystyrene).

A laser beam 368 may perform the exposure. The beam may locally heat up the layer 362 to its glass transition temperature, so that it may become soft or even fluid. The magnetic field created by an electro-magnet or a permanent magnet 370, placed over or beneath the plate base 360, may attract and/or may move the magnetic particles 364 to their new position 366 on the bottom or top of the emulsion layer 364. The upward/downward moving particles pull or compress the material, depending on their direction, and create flexographic or gravure type plate structure. In case of upward particle movement, care should be taken not to expel magnetic particle off the coating and not to damage the coating while in its soft or even fluid state.

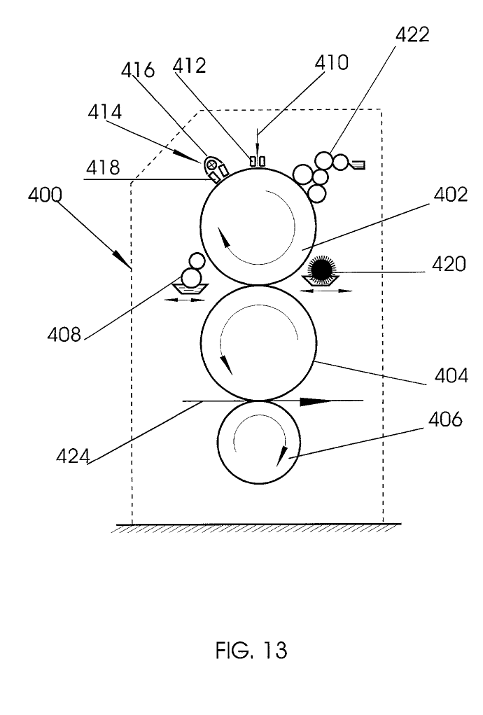

It is clear that the materials described with reference to FIGS. 9 and 12 may be coated on both flat and cylindrical surfaces. When coated on cylindrical surfaces, they are mounted on a press to be used in an on-press imaging system. FIG. 13 is a schematic illustration of a press with printing cylinders, coated with the erasable offset printing plate coating of FIG. 9, or with the erasable relief printing plate material of FIG. 12.

A press 400 may comprise a plate cylinder 402, a blanket cylinder 404, and an impression cylinder 406. The plate cylinder 402 may be coated by a coating similar to the one described with reference to FIGS. 9 and 12. The cylinder 402 may be pre-coated and removable, or alternatively the press 400 may be equipped with a coating device 408. The coating device 408 has working and idle positions. A laser beam 410 may perform the exposure. The beam 410 may locally heat up the coating layer on the cylinder to above its glass transition temperature, where the emulsion layer may become soft or even fluid. A multiple pole electro-magnet or a plurality of permanent magnets 412 that create a uniform magnetic field may be placed above the plate cylinder 402. This uniform magnetic field may cause the magnetic particles to move to their new position, on the bottom or on the top of the coating layer, depending on the polarity of the magnetic field. The exposed area may now contain only the coating, which is oleophilic/hydrophobic. The printing may be performed like on a regular press. Numerals 422 and 424 respectively indicate the inking system and the paper.

Upon completion of the printing process, the plate may be erased by a plate-erasing device 414 comprising a heat source 416, such as an IR lamp and an arrangement of permanent or electric magnets 418. The heat source 416 may heat up the whole coating layer to the glass transition temperature. The arrangement of permanent or electric magnets 418 may create a uniform magnetic field. This magnetic field may cause the magnetite particles to move to their initial position flat was existing before the imaging, or to the far-most position physically possible. The process may be repeated many times. When the coating layer has to be renewed, the old layer may be removed by a cleaning device 420 and the cylinder re-coated by coating device 408.

All image erasure processes have been described earlier. It might be added that in some cases, depending on the magnetite particles size and load, it might be possible to erase/ record the information just by using the centrifugal force.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An ablatable lithographic printing member comprising a base material and a coating provided thereon, said coating comprising at least one polymeric layer containing magnetic particles embedded therein.

2. The printing member of claim 1, wherein said base material is an image-bearing cylinder surface and said coating is coated on-press.

3. The printing member of claim 1, wherein the topmost layer comprises an ink-repelling silicone.

4. The printing member of claim 1, wherein said printing member is configured such that after selective ablation, areas exposed by said ablation and unexposed areas of said printing member are configured to have opposed chemical affinities with respect to at least one of water and ink.

5. An abatable printing member configured for use as a flexographic printing member and comprising a base material and a coating provided thereon, said coating comprising at least one polymeric layer containing magnetic particles embedded therein.

6. The printing member of claim 5, wherein said coating comprises wax.

7. An erasable lithographic printing member comprising a base material and an emulsion coating provided thereon, wherein said emulsion coating is a polymer dispersed with magnetic particles, said emulsion having a relatively low glass transition temperature.

8. The printing member of claim 7, wherein said base material is an image-bearing cylinder surface and said coating is coated on-press.

9. A erasable printing member configured for use as a relief printing member and comprising a base material and an emulsion coating provided thereon, wherein said emulsion coating is a polymer dispersed with magnetic particles) said emulsion having a relatively low glass transition temperature,

10. An imaging apparatus comprising:
a rotating drum adapted to receive a printing member, said printing member comprising at least one polymeric layer containing magnetic particles embedded therein;
an imaging unit;
at least one pair of permanent magnets or electromagnets, adapted to be in proximity to said printing member; and
a thin transparent film positioned between said printing member and said at least one pair of magnets or electromagnets.

11. A printing system comprising:
means for placing a coating on image-bearing cylinder;
means for heating said coating;
means for generating a magnetic field configured for controlling the topography of said coating having a first polarity; and
means for erasing an image from said coating after printing.

12. The system of claim 11, wherein the means for erasing after printing comprises means for reversing the polarity of said means for generating a magnetic field, whereby to reinstate said coating.

13. A method for imaging an erasable printing member, said erasable printing member comprising a polymeric emulsion coating having magnetic particles, said emulsion coating having a relatively low glass transition temperature comprising locally heating up said emulsion coating to a temperature above said glass transition temperature and creating a magnetic field beneath or above said erasable printing member to selectively attract and move said magnetic particles to a new position, at the bottom or top of said coating, depending on the orientation of the magnetic field relative to said erasable printing member.

14. The method of claim 13, further comprising applying a permanent magnetic field generally concurrently with applying said emulsion coating to a base material of said printing member, thereby arranging said magnetic particles to occupy a permanent and organized position on the top or bottom of said coating layer.

15. A method for reinstating an erasable printing member comprising after printing heating an imaged layer to a temperature, which is about said glass transition temperature and creating a magnetic field beneath or above said erasable printing member.

16. A method comprising.
coating a printing cylinder with a coating having a low glass transition temperature;
heating said coating to or above said glass transition temperature;
selectively exposing said printing cylinder to a magnetic field, thereby changing the topography of said coating; and
erasing said exposed coating after printing, by exposing it to a suitable magnetic field.
